(19) United States
(12) Patent Application Publication
(10) Pub. No.: US 2012/0243111 A1
(43) Pub. Date: Sep. 27, 2012

(54) Wafer Lens Manufacturing Method

(76) Inventors: Yasushi Iijima, Hachioji-shi (JP); Naohiro Kageyama, Hachioji-shi (JP)

(21) Appl. No.: 13/392,775

(22) PCT Filed: Aug. 27, 2010
(86) PCT No.: PCT/JP2010/064581

§ 371 Date: Jun. 13, 2012

(30) Foreign Application Priority Data
Aug. 31, 2009 (JP) 2009-199791

(51) Int. Cl. G02B 7/02; B29C 59/16; B32B 37/00

(52) U.S. Cl. 359/811; 156/64; 156/272.8

(57) ABSTRACT

Provided are a wafer lens and a wafer lens manufacturing method which makes it possible to favorably manage lens inspection information. The wafer lens is formed by laying a diaphragm and an ID recording section on a glass substrate and covering the diaphragm and the ID recording section with a resin layer which forms optical members, the ID recording section having individual identification information (a wafer ID) of the wafer lens recorded therein. Further, the wafer lens manufacturing method comprises: an inspection step of inspecting optical components structured in the wafer lens; an identification information reading step of reading the wafer ID from the ID recording section; and a storage step of storing, in a management server, inspection information obtained in the inspection step while associating the inspection information with the wafer ID of the inspected wafer lens and further with component IDs thereof.

### FIELD OF THE INVENTION

The present invention relates to a wafer lens and wafer lens manufacturing method.

Conventionally in the optical lens manufacturing field, a study has been made to develop a technique of manufacturing an optical lens having a high heat resistance by installing on a glass plate a lens section (optical member) made of curable resin such as a photo-curable resin (see Patent Literature 1, for example).

In one of the optical lens manufacturing methods based on this technique, a diaphragm made of metallic film for adjusting the amount of incoming light is formed on the surface of a glass plate, and a plurality of optical members made of curable resin are laid on the surface of the diaphragm, so that a so-called “wafer lens” is produced. After that, a plurality of lenses are integrally formed and are laminated and bonded by holding a space in-between or abutting on a projection formed simultaneously with the optical surface, so that a plurality of lens sets are formed. After that, the glass plate is cut. This manufacturing method cuts off the optical lens manufacturing cost. Further, the aforementioned wafer and a plurality of lens sets are cut into separate pieces, which are further mounted on an image sensor. Further, the sensor formed similarly in a wafer is combined with a wafer lens and a plurality of lens sets and is then cut off into separate pieces. Thus, high-volume production of compact, high-resolution image capturing units including a sensor can be achieved. Industrial attention is being directed to this technique.

Normally, a resist pattern is formed on the surface of the glass plate by photolithography. After that, a diaphragm is formed on the glass plate by repeating the processes of etching, vapor deposition and plating. However, this method includes a great number of steps, and is required to be more simplified.

To simplify the manufacturing step in the formation of a diaphragm, the present applicants proposed a wafer lens manufacturing method in the Japanese Patent Application No. 2008-116639 wherein one surface of a substrate is coated with a photoresist including carbon black and the photoresist is then developed by exposition to light, so that a diaphragm having a prescribed pattern is formed.

### EARLIER TECHNOLOGICAL LITERATURE

### Patent Literature

Patent Literature Japanese Examined Patent Application Publication No. 3926380

### SUMMARY OF THE INVENTION

### Problems to be Solved by the Invention

Incidentally, before being separated into individual lens units, a wafer lens is subjected to various processes up to inspection as a single wafer or as an assembled wafer set composed of a plurality of wafers assembled into one piece. This is intended to improve the manufacturing efficiency.

This method has a problem that, since lenses having been inspected are each held integrally by a wafer lens, assorting management for each lens—e.g., removing faulty lenses based on the inspection result—cannot be made.

In view of the problems described above, it is an object of the present invention to provide a method for manufacturing a wafer lens wherein the occurrence of faulty lens is minimized by an effective use of inspection information obtained in the step of inspection, and a method for manufacturing a wafer lens suitable for managing individual information such as lens inspection information, and a wafer lens capable of ensuring an effective management of lens inspection information.

### Means for Solving the Problems

To achieve the above-mentioned object, a method for manufacturing a wafer lens wherein an optical member made of curable resin is formed on a substrate reflecting one aspect of the present invention includes: a step of measuring the back focus of each lens unit on the wafer; a step of selecting a spacer having an optimum thickness for combination with the wafer based on the measurement result of the back focus; and a step of bonding the wafer to the selected spacer.

In the aforementioned first aspect, the step of selecting a spacer having an optimum thickness for combination with the wafer based on the measurement result of the back focus preferably includes a step of recording in a data file the information for specifying an optimum spacer to be selected, and the information for identifying the non-conforming lens units when the optimum spacer has been selected.

A wafer lens with the optical member made of curable resin formed on a substrate reflecting the second aspect of the present invention includes a diaphragm as an optical component and an identification information recording section for recording the individual identification information of the wafer mounted on the substrate, wherein the diaphragm and identification information recording section are covered with a resin layer for forming the aforementioned optical component.

In the aforementioned second aspect, the aforementioned diaphragm and the identification information recording section are preferably formed of the same material arranged on the same layer.

The aforementioned same material is more preferably made of a lightproof photoresist.

A wafer lens manufacturing method reflecting the third aspect of the present invention includes:

1) a lamination step for laminating the layer of the same material constituting a diaphragm as an optical component and an identification information recording section for recording the individual identification information of the wafer lens, on the substrate;

2) a patterning step of forming the diaphragm by selectively removing the layer of the same material by patterning;

3) an identification information recording step for forming the identification information recording section by selectively processing the layer of the same material by a laser marker;

4) a molding step of filling a curable resin between the surface of the substrate having the diaphragm and the identification information recording section formed thereon, and a molding die, forming an optical member by the molding die using a curable resin as a material, and coating the diaphragm and the identification information recording section with the curable resin, and

5) a curing step of curing the curable resin.

In the aforementioned third aspect, it is preferred that a layer of lightproof photoresist should be used as the layer of the same material in the lamination step, and the layer of lightproof photoresist should be selectively removed in the identification information recording section subsequent to exposure and development of the layer of lightproof photoresist in the patterning step, so that the identification information recording section is formed

The aforementioned third aspect preferably includes: an inspection step of inspecting the optical member formed on a wafer lens subsequent to the curing process; an identification information reading step for reading the individual identification information of a wafer lens from the identification information recording section; and a storage step of storing in a management server inspection information obtained in the inspection step by associating the inspection information obtained from the inspection step with the individual identification information of the wafer lens to be inspected.

Further, the aforementioned third aspect preferably includes a storage step of presetting the component identification information for identifying the individual optical member for each area for forming the optical member on a wafer lens, and associating the inspection information on each optical member obtained in the inspection step with the individual identification information on the wafer lens to which the optical member to be inspected belong, and the component identification information on the optical member to be inspected, so that this inspection information is stored in a management server.

Further, the aforementioned third aspect preferably includes a display step wherein a surface map of a wafer lens is displayed on an image display device, and the inspection information of the optical member is displayed on the position corresponding to the region for forming the optical member to be inspected on the surface map, based on the individual identification information, component identification information and inspection information associated with them.

Further, the aforementioned third aspect preferably includes an inspection failure recording step wherein a laser marker is used to selectively process the optical member to be determined as having failed in the inspection, based on the inspection information after the inspection step, and a visual display is formed to indicate that this optical member has failed in the inspection.

### Effects of the Invention

The wafer lens manufacturing method reflecting the first aspect of the present invention selects, based on the result of measuring the back focus of each lens unit on a wafer, the spacer having the optimum thickness for combination with the wafer. This structure minimizes the occurrence of faulty lenses.

The wafer lens reflecting the second aspect of the present invention identifies each wafer lens by allowing a reading device to read the individual identification information of the wafer lens from the identification information recording section. This individual identification information is used to ensure effective individual information management.

A diaphragm as an optical member and an identification information recording section having the individual identification information of the wafer lens recorded thereon are laid on the substrate, and the diaphragm and identification information recording section are covered with the resin layer for forming the optical member. This structure enhances the information storage performance and tampering preventive performance.

At the same time the coating layer of the identification information recording section is made of the resin layer forming the optical member. This structure ensures protection against an increase in the number of the steps or materials for forming the coating layer of the identification information recording section.

Further, the diaphragm and identification information recording section are formed of the same material arranged on the same layer. This permits lamination of the constituting layers of the identification information recording section in the same step as that for the lamination of the diaphragm constituting layer. This structure ensures protection against an increase in the number of the steps or materials for laminating the constituting layers of the identification information recording section.

The manufacturing step can be simplified by using a lightproof photoresist as the constituting material of the diaphragm and identification information recording section, as compared to the method of using the conventional metallic film.

The wafer lens manufacturing method reflecting the third aspect of the present invention produces a wafer lens having the individual identification information on the wafer lens recorded thereon. This structure provides the same advantages as above, and ensures effective management of the lens inspection information.

### BRIEF DESCRIPTION OF THE DRAWINGS

FIG. 1 is a plan view representing ¼ part of a first wafer lens in one embodiment of the present invention;

FIG. 2 is a cross section (taken along arrow line A-A) of a wafer lens set in one embodiment of the present invention;

FIG. 3 is a plan view representing ¼ part of a second wafer lens in one embodiment of the present invention;

FIG. 4 is a block diagram showing the flow of the wafer lens manufacturing method (including the inspection step) in one embodiment of the present invention;

FIG. 5 is a schematic diagram representing an MTF/FB test instrument in one embodiment of the present invention;

FIG. 6 is a detailed plan representing a light source of the MTF/FB test instrument in FIG. 5;

FIG. 7 is a cross sectional view showing a warpage correcting jig in one embodiment of the present invention;

FIG. 8 is a side view showing a distance sensor with respect to the illustrated wafer lens;

FIG. 9 is a schematic diagram showing a test instrument for capturing of an undesired image in one embodiment of the present invention;

FIG. 10 is a map display drawing corresponding to the wafer lens of the inspection information (error data) in one embodiment of the present invention; and

FIG. 11 is a drawing showing a lens unit mounted on an image pickup element.

### DESCRIPTION OF EMBODIMENTS

The following describes one embodiment of the present invention with reference to drawings: The following illustrates only one embodiment of the present invention without being restricted thereto.

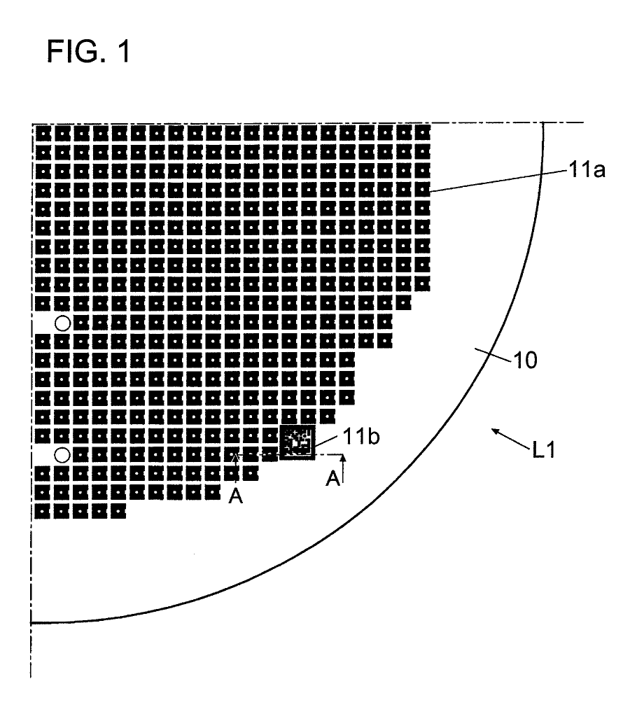

Referring to FIGS. 1 through 3, the following describes the wafer lens in one embodiment of the present invention.

The wafer lens of the present invention is intended as the first and second wafer lenses. The first wafer lens L1 and the second wafer lens L2 are provided with individual identification information (hereinafter referred to as “wafer ID”.

As shown in FIG. 1, the wafer lens L1 includes a glass substrate 10, diaphragm 11a and ID recording section 11b formed on the surface of the glass substrate 10. Many diaphragms 11a, 11a, 11a, . . . are provided on the large portion at the center of the glass substrate 10. The ID recording section 11b is formed around many diaphragms 11a, 11a, 11a, . . . .

The diaphragms 11a and ID recording sections 11b are formed of the same material arranged on the same layer 11. A lightproof photoresist is used in the present embodiment. A photoresist mixed with carbon black is used as a lightproof photoresist

The ID recording section 11b is composed of two-dimensional barcodes. The ID recording section 11b includes a record of the information represented in binary notation composed of a specified number of digits. This information contains the wafer ID of the first lens L1, and can be read by a barcode reader.

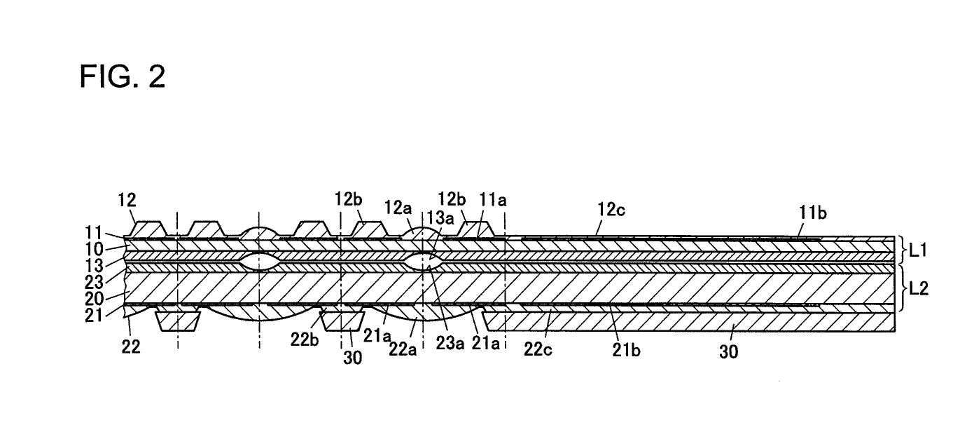

As shown in FIG. 2, the diaphragm 11a and ID recording section 11b are covered with a photocurable resin layer 12 constituting an optical member 12a and others.

The photocurable resin layer 12 is formed on the surface where the diaphragm 11a and ID recording section 11b of the glass substrate 10 are formed, and constitutes a convex lens section 12a, lens peripheral projection 12b and peripheral plate 12c. The diaphragm 11a is covered with the convex lens section 12a, lens peripheral projection 12b and others, and the ID recording section 11b is covered with the peripheral plate 12c.

A resin layer 13 is formed on the side of the glass substrate 10 opposite to the resin layer 12. The resin layer 13 forms a concave lens section 13a at the position coaxial with the convex lens section 12a.

The component made of one convex lens section 12a, one diaphragm 11a and one concave lens section 13a correspond to one unit of the component, and is unitized with other wafer lens L2, spacer 30 and image sensor (not illustrated) in the state being held by wafer.

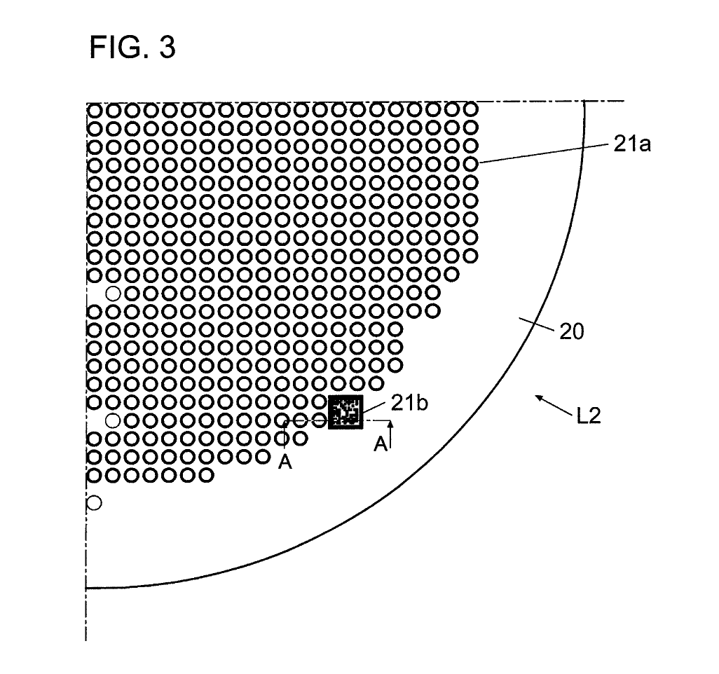

As shown in FIG. 3, the second wafer lens L2 is provided with a glass substrate 20, and a diaphragm 21a and ID recording section 21b formed flat with the glass substrate 20. Many diaphragms 21a, 21a, 21a, . . . are formed on the greater portion of the center of the glass substrate 20. An ID recording section 21b is formed on the periphery of the many diaphragms 21a, 21a, 21a, . . . . The diaphragms 21a and ID recording section 21b are formed of the same material arranged on the same layer 21, and a lightproof photoresist is used in the present embodiment. This lightproof photoresist is mixed with carbon black.

The ID recording section 21b is formed of two-dimensional barcodes. The ID recording section 21b includes a record of the information represented in binary notation composed of a specified number of digits. This information contains the wafer ID of the second lens L2, and can be read by a barcode reader.

As shown in FIG. 2, the diaphragm 21a and ID recording section 21b are covered with a photocurable resin layer 22 constituting a convex lens 22a and others.

The resin layer 22 is formed on the surface wherein the diaphragm 21a and ID recording section 21b of the glass substrate 10 are formed, and constitutes the convex lens 22a, lens peripheral projections 22b and 22c. The diaphragm 21a is covered with the convex lens 22a, lens peripheral projections 22b and 22c, and the ID recording section 21b is covered with the lens peripheral projection 22c.

A resin layer 23 is formed on the side of the glass substrate 20 opposite to the resin layer 22. The resin layer 23 forms a concave lens section 23a at the position coaxial with the convex lens section 22a.

The component made of one convex lens section 22a, one diaphragm 21a and one concave lens section 23a correspond to one unit of the component, and is unitized with other wafer lens L1, spacer 30 and image sensor (not illustrated) in the state being held by wafer.

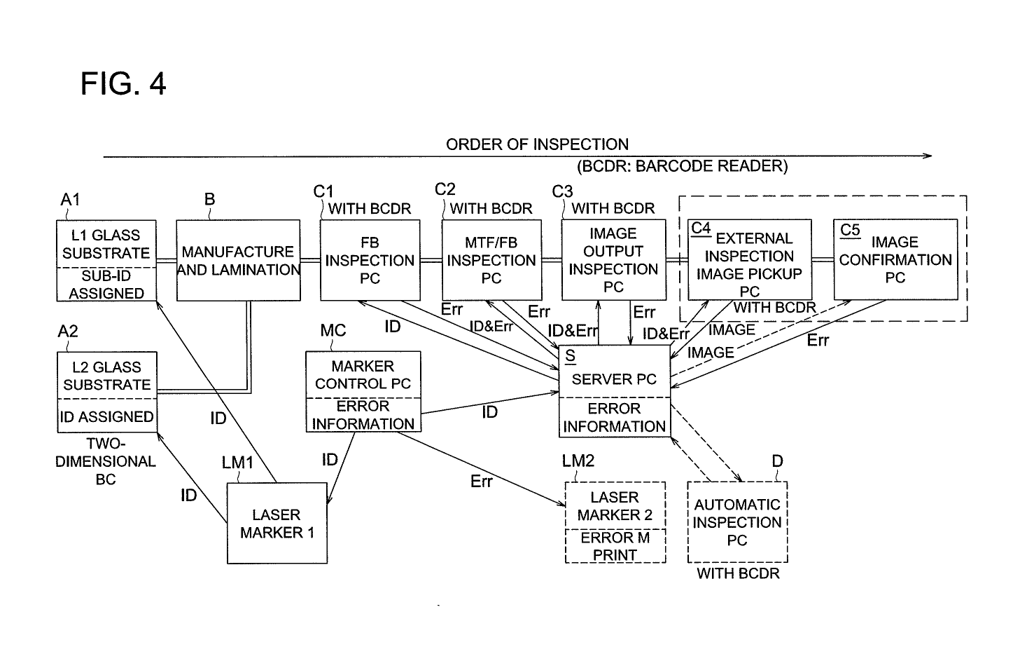

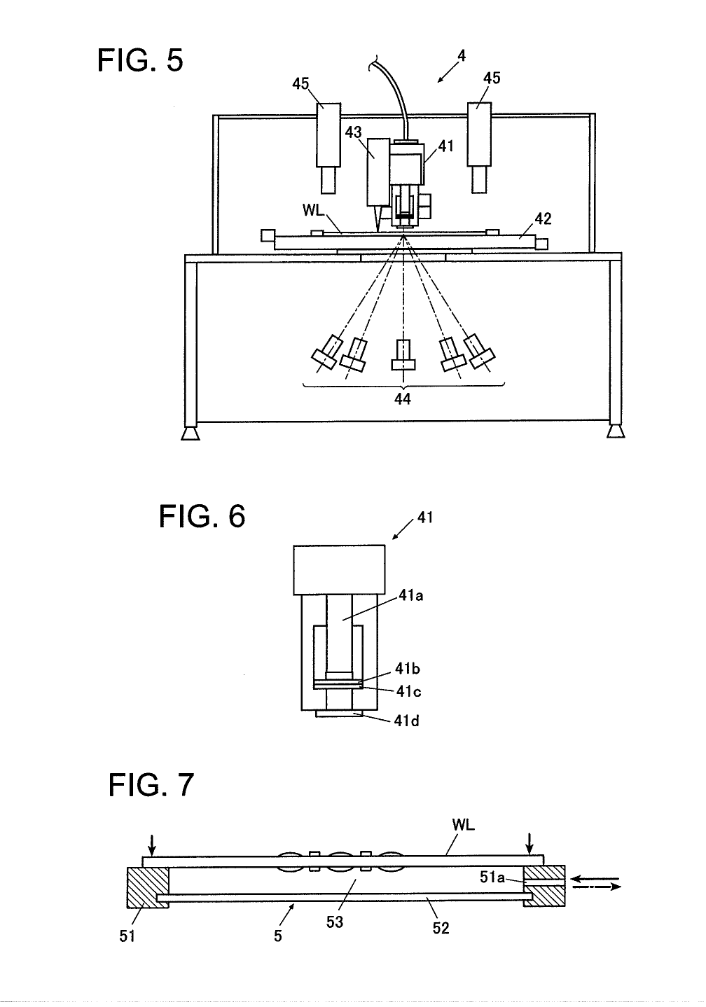

The following describes the method for manufacturing the wafer lens in one embodiment of the present invention with reference to FIGS. 4 and 5.

The same material layer 11 (21) constituting the diaphragm 11a (21a) as an optical member and ID recording section 11b (21b) with the wafer ID to be recorded thereon is laminated on the glass substrate 10 (20) (in the laminating step). The photoresist mixed with carbon black is used as the material layer 11, and is coated on the glass substrate 10.

The material layer 11 (21) is selectively removed by the processing of patterning exposure and subsequent development so that the diaphragm 11a (21a) is formed (patterning process).

The material layer 11 (21) left unremoved on the periphery of the diaphragm 11a (21a) is selectively removed by the laser marker LM1 shown in FIG. 4, so that the ID recording section 11b (21b) is formed (equivalent to blocks A1 and A2 in the identification information recording step). In this case, formation of the ID recording section is equivalent to recording of the wafer ID. The laser marker LM1 is controlled by the marker control PC (block MC) and the information on the wafer ID is stored in the marker control PC. The marker control PC controls the laser marker LM1 and assigned wafer ID to each wafer lens.

The wafer ID assigned by the marker control PC (block MC) is sent from the marker control PC to a server PC (block S) and a data file for each wafer ID is created by the server PC. The manufacturing information such as the date of manufacture can be recorded on the data file.

When the data file is created, the server PC sets up the component identification information for identifying the lens on the wafer lens. The component identification information for identifying the lens on the wafer lens is provided in conformity to each lens on the wafer lens. Each lens and component identification information thereof are correlated with each other, depending on the position in the lens forming area. To be more specific, address information is set in each lens forming area and this address information is used as the identification information of the lens to be formed therein. This saves the trouble of providing a product with the component identification information for identification of lenses.

The inspection information on the lens on the wafer lens identified by this wafer ID is stored in the data file assigned with the wafer ID as the production history information, in the form associated with the address information of the relevant lens.

After the wafer ID has been assigned, the system goes to the subsequent wafer lens manufacturing step and the step of laminating and combining two wafer lenses, as shown by the block B of FIG. 4.

In the first place, a photocurable resin is filled between the surface of the glass substrate 10 (20) with the diaphragm 11a (21a) and ID recording section 11b (21b) formed thereon, and the molding die (not illustrated). The optical member (convex lenses 12a, 22a), lens peripheral projection 12b (2b, 22c), and peripheral plate 12c are formed by the molding die, using the photocurable resin as material. The diaphragm 11a (21a) and ID recording section 11b (21b) are covered with the curable resin (molding step). In this step, for example, the resin in the state of monomer (prior to curing) is placed on the glass substrate 10 (20), and the molding die is pressed against the resin from the top.

Further, the resin is cured by exposure to light (curing step). In this case, light is applied from the side of the glass substrate 10 (20), or from the molding die which is made of a transparent material such as a transparent resin.

The resin layer 13 (23) on the other surface of the glass substrate 10 (20) is also formed in the similar manner, so that the first wafer L1 and second wafer L2 are produced.

After that, as shown in FIG. 2, the surface of the resin layer 13 of the first wafer L1 and the resin layer 23 of the second wafer L2 are put together to laminate a dual wafer, which is bonded and fixed until a wafer set (L1+L2) is formed.

This is followed by the step of measuring the back focus BF of each lens unit on the wafer set (L1+L2) for the purpose of selecting a spacer 30 having the optimum thickness.

The FB inspection PC (block C1) controls the FB test instrument and measures the back focus BF of each lens unit on the wafer set (L1+L2) sequentially. At the same time, the FB inspection PC (block C1) allows the attached barcode reader to read the wafer ID of the second wafer lens L2 from the ID recording section 21b on the wafer set (L1+L2) to be tested. Thus, the ID to be tested is identified.

The wafer set (L1+L2) can be identified either by the wafer ID of the first wafer lens L1 or by the wafer ID of the second wafer lens L2. Use of one of the wafer IDs is sufficient. In the present embodiment, the wafer ID of the second wafer lens L2 and the data file thereof will be used

It goes without saying that the wafer ID of the first wafer lens L1 and the data file thereof are used for the information management of the first wafer lens L1 as a single body, and the wafer ID of the second wafer lens L2 and the data file thereof are used for the information management of the second wafer lens L2 as a single body.

The FB inspection PC downloads the data file of the corresponding ID from the server PC, and records the inspection information on the data file. Then the information is uploaded on the serve PC so that the server PC updates the data file.

The inspection information recorded on the data file by the FB inspection PC includes the information for identifying the optimum spacer 30 to be selected, and the information for identifying the lens unit that will be non-conforming when this spacer has been selected (error information Err).

The following describes the standards of the back focus FB.

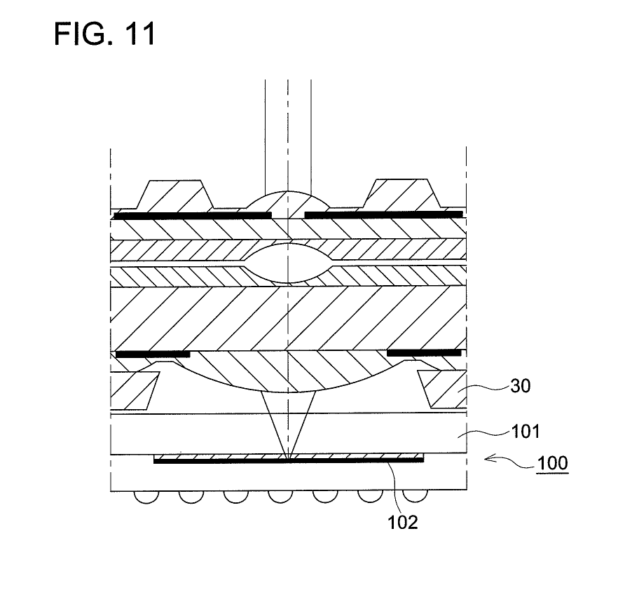

FIG. 11 shows a lens unit mounted on an image pickup element 100 (CMOS sensor, etc.). The lens unit is fixed on the pickup element by bonding the spacer 30 with a cover glass 101 of the image pickup element 100.

In this case, due to lack of a focus adjusting mechanism in conformity to the distance of a subject, it is necessary to use a pan focus lens wherein the focus is adjusted from a subject at a long distance to a subject at a short distance. Thus, the focus on an object at a distance of U/2 from an infinitely long distance can be considered to have been adjusted in terms of geometrical optics, by achieving agreement between the image point position of the lens unit and the position of the photoelectric converter 102 of the image pickup element 100 in the optical axial position, at a hyperfocal distance U≈f²/(F×2×P) (where f: focal distance of a lens unit, F: F—number of lens unit, P: pixel pitch of image pickup element). I the case of f=3 mm, F=2.8, and P=0.00175 mm, for example, if the thickness of the spacer 30 is set so as to achieve agreement between the image point of the lens unit at a hyperfocal distance U≈3²/(2.8×2×0.00175)=918 mm (approximately 92 cm) and the photoelectric converter 102 of the image pickup element in terms of a reference subject range, the focus can be adjusted up to a distance of 46 cm from an infinitely long distance. Further, the reference subject need not always be set at a hyperfocal distance. For example, when a subject at a longer distance is of greater concern, the reference subject distance should be set at a point farther than the hyperfocal distance. To put it more specifically, reduce the thickness of the spacer 30 slightly.

The focus setting accuracy at a reference range should be kept at a level that does not exceed 0.5 times the focal depth (generally, calculated by ±F×2×P). In the aforementioned example, the focus setting accuracy is preferably kept at a level that does not exceed ±0.5×2.8×2×0.00175=±0.0049 mm. Thus, the thickness of the spacer 30 for setting the optimum focus should be so set as to ensure that the FB of the greatest possible number of the lens units inside the wafer set can be kept within this scope. Accordingly, in terms of the thickness of the spacer to be prepared in advance, several types of spacers having a difference in thickness with a pitch smaller than 0.0049 mm are preferably prepared in the aforementioned case. In an alternative procedure, the FB mean value of the lens unit inside the wafer set is measured. After that, the plate glass is ground to adjust the thickness of the spacer 30 so as to get a desired focal position.

The standards for the back focus BF are determined as follows: For example, the first step is to find the mean value of the FB of all the lens units inside the wafer set. The measurements kept within the range of FB tolerable variation that has been preset with consideration given to focal depth are considered as conforming to the standards, and the measurements in excess of this range is considered as non-conforming. Inspection information is recorded according to this principle.

After that, the wafer set (L1+L2) is combined with the spacers 30 selected based on the inspection information recorded in the data file of the ID. Then they are laminated as shown in FIG. 2, and are bonded and fixed in position.

This is followed by the step of MTF/FB inspection.

The MTF/FB inspection PC (block C2) controls the MTF/FB test instrument 4 of FIG. 5 so that each lens unit on the wafer set (L1+L2+spacer 30) is subjected to the MTF/FB inspection.

As shown in FIG. 5, the MTF/FB test instrument 4 includes a light source 41 for applying a prescribed amount of light to the lens, an automatic XY stage 42 that mounts the wafer lens WL and move the same in the two-axis X-Y direction perpendicular to the direction of irradiation (Z axis), a distance sensor 43 fixed on the light source 41 to measure the distance from the lens, a measuring optical system 44 provided with multiple CCD cameras, and cameras 45 for adjusting the wafer rotation. The light source 41 and distance sensor 43 fixed thereon are controlled in the movement in the vertical direction (Z-axis direction).

As shown in FIG. 6, the light source 41 is provided with a halogen fiber 41a, band pass filter 41b, diffusion plate 41c and chart 41d.

The wafer set (L1+L2+spacer 30) used for the aforementioned manufacturing process is mounted as the wafer lens WL of FIG. 5.

The MTF/FB inspection PC allows one of the CCD cameras of the measuring optical system 44 to measure the value of the MFT (Modulation Transfer Function) at the center of a lens, and moves the light source 41 in the vertical direction to identify the FB that maximizes the MTF value. The MTF/FB inspection PC calculates the FB value based on the output from the distance sensor 43. Further, the MTF/FB inspection PC uses other four cameras of the measuring optical system 44 to measure the MTF value on the periphery of the lens at the FB value, and calculates the percentage of the MTF value on the periphery of the lens with respect to the maximum value at the center of the lens.

The MTF/FB inspection PC controls the MTF/FB test instrument 4, and performs the aforementioned measurement and calculations for each irradiation of different frequencies. Based on the values having been obtained, the MTF/FB inspection PC selects the non-conforming lens unit

The MTF/FB inspection PC uses the attached barcode reader to read the wafer ID of the second wafer L2 from the ID recording section 21b on the wafer set (L1+L2+spacer 30) and identifies the ID of the object to be tested.

The MTF/FB inspection PC downloads the data file of the relevant ID from the server PC, and records the inspection information into this data file. This information is then uploaded to the server PC, which updates the data file.

The inspection information recorded on the data file by the MTF/FB inspection PC includes the information (error information Err) for identifying the non-conforming lens unit.

The following describes the method for correcting the warping of the wafer lens WL for MTF/FB inspection and image output inspection. If the wafer lens WL to be tested is warped, correct measurements cannot be obtained. Correction of warpage of the wafer lens WL provides an effective means for accurate measurement.

A warpage correcting jig 5 of FIG. 7 is used to correct the warpage of the wafer lens WL. The warpage correcting jig 5 includes a frame member 51 having a vent 51a, and a sealing glass 52 for enclosing one surface of the frame member 51.

The wafer lens WL is mounted on the other surface of the frame member 51. The edge of the wafer lens WL is adjusted to the frame member 51. They are brought in close contact and are fixed in position. Sealing is provided to protect against air leakage. They can be brought in close contact and sealed by pressing the edge of the wafer lens WL mechanically against the frame member 51, or by forming a porous vacuum frame at the position wherein the wafer lens WL of the frame member 51 is mounted, so that the wafer lens WL is held in position by suction. Other proper methods can also be used.

The warpage correcting jig 5 holding the wafer lens WL is mounted on the automatic XY stage 42 of the MTF/FB test instrument 4. The position of the distance sensor 43 in the Z-axis direction is fixed and the automatic XY stage 42 is moved. The warpage of the wafer lens WL is measured by the distance sensor 43. Warpage can be measured by other means than the MTF/FB test instrument 4

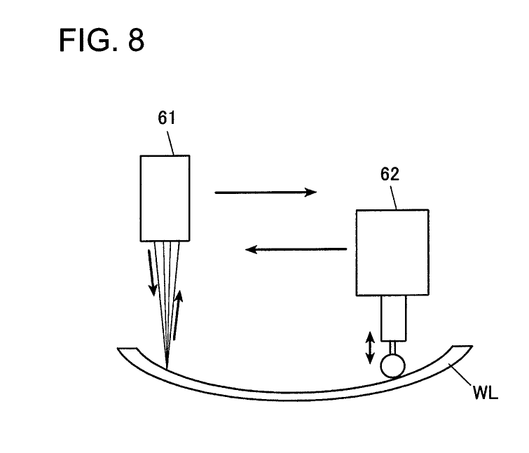

Any one of the autocollimator 61 of FIG. 8, the contact type displacement meter 62 and other laser trigonometric displacement meters can be used as the distance sensor for the wafer lens.

If the wafer lens WL is convexed toward the top n FIG. 7 after measurement of the warping of the wafer lens WL in the aforementioned procedure, air is sucked from the enclosed space 53 by a pneumatic pump through the vent 51a. If the lens is concaved toward the bottom, air is pressed into the enclosed space 53, so that the amount of warpage of the wafer lens WL is reduced and the warpage is corrected to a flat level. If the warpage of the wafer lens WL has been corrected, the pressure inside the enclosed space 53 is maintained so as to keep the wafer lens WL in the corrected state.

Use of the warpage correcting jig 5 allows the wafer lens WL to be measured after the warpage has been removed.

If the side opposite to the wafer lens WL is sealed by a sealing glass 52, the sealing glass 52 allows passage of light. This provides an effective means for optical measurement of the wafer lens WL.

This is followed by the step of image output inspection.

The image output inspection PC uses the attached barcode reader to read the wafer ID of the second wafer L2 from the ID recording section 21b on the wafer set (L1+L2+spacer 30) and identifies the ID of the object to be tested. The image output inspection PC downloads the data file of the relevant ID from the server PC. By referencing the error information Err, the image output inspection PC identifies the lens units which have been rejected as non-conforming in the MTF/FB inspection at the time of MTF/FB inspection, and excludes such lens units out of the scope of inspection. Then the remaining lens units are subjected to image output inspection.

The image output inspection PC (block C3) controls an undesired image capturing tester 7 to test the image output performance of the lens unit on the wafer set (L1+L2+spacer 30).

The undesired image capturing tester 7 is provided with a measuring head 70 integrally containing a CCD 71, image output board 72 and distance sensor 73. This measuring head 70 is controlled in the movement in the vertical direction (Z-axis direction).

Further, the undesired image capturing tester 7 includes an automatic XY stage 74, uniform light source 75, and alignment cameras 76, 76. The frame 77 and warpage correcting jig 5 are shared with the MTF/FB test instrument 4.

The image output inspection PC (block C3) is provided with a motion controller 81, D/IO board 82 and image input board 83. The motion controller 81 is connected to the actuator for the movement of the measuring head 70 through a driver 91. The motion controller 81 is also connected to the actuator for the movement of the automatic XY stage 74 through a driver 92. The D/IO board 82 is connected to the uniform light source 75 so that light is outputted from the uniform light source 75. The image input board 83 is connected to the alignment cameras 76, so that the captured image of the alignment cameras 76 is loaded inside. The distance sensor 73 is also connected to the image output inspection PC.

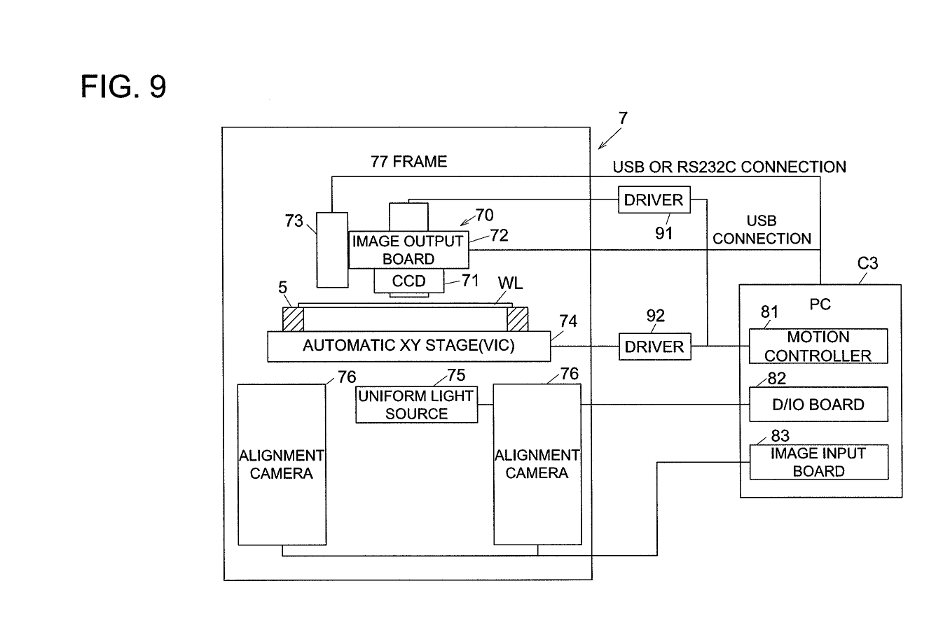

The wafer set (L1+L2+spacer 30) used for the aforementioned manufacturing process is mounted as the wafer lens WL of FIG. 9.

After inspection, the image output inspection PC records the inspection information in the relevant data file, and uploads the information to the server PC, which then updates the data file.

The inspection information recorded in the data file by the image output inspection PC includes the information (error information Err) for identifying the non-conforming lens unit.

External inspection is performed by using the external inspection image pickup PC (block C4) and image confirmation is performed by using image confirmation PC (block C5). These inspections can be replaced by the automatic inspection PC (block D) that automates the work to be performed by the inspector.

These PCs (C4, C5, D) use the attached barcode reader to read the wafer ID of the second wafer L2 from the ID recording section 21b on the wafer set (L1+L2+spacer 30) to be inspected, and identifies the ID of the object to be tested. These PCs download the data file of the relevant ID from the server PC. By referencing the error information Err having been inspected, these PCs exclude out of the scope of inspection the lens units which have been rejected as non-conforming. All the remaining lens units are inspected or the images thereof are outputted for inspection. These PCs records the inspection information in the relevant data file and upload the information to the server PC, which then updates the data file.

The inspection information recorded in the data file by these PCs (C4, C5, D) includes the information (error information Err) for identifying the non-conforming lens unit.

In the middle or upon termination of the aforementioned inspections, the surface map of the wafer lens is displayed on the image display device in response to the operator's request or whenever required. Based on the data file identified by the wafer ID of the wafer lens to be tested, the inspection information of the lens unit is displayed in the area wherein the optical component to be tested on the surface map is formed.

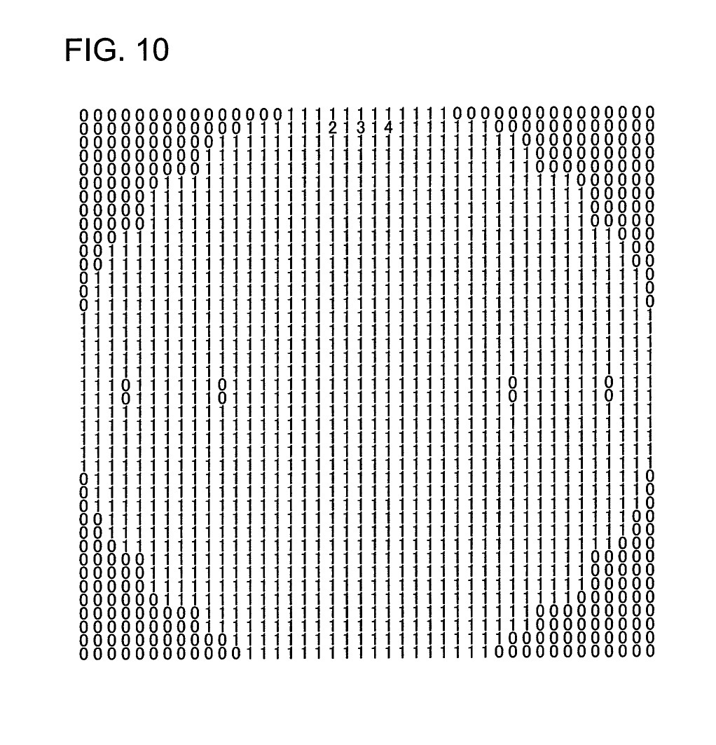

In the present embodiment, as shown in FIG. 10, the error information Err of the lens unit recorded on the data file is displayed at the position of the relevant lens unit on the surface map of the wafer lens.

In FIG. 10, “0” indicates the invalid region wherein a lens is not intended to be formed. “1” denotes a normal lens having passed the inspection, “2” shows the lens having been rejected as non-conforming in the MTF/FB inspection, “3” represents the lens having been rejected as non-conforming in the image output inspection and “4” indicates the lens having been rejected as non-conforming in the external inspection.

Upon termination of all the aforementioned inspections, the optical components to be determined as non-conforming, based on the error information Err recorded in the data file, namely, the lenses marked with “2”, “3” and “4” in FIG. 10 are provided with processing. Namely, the surface of the convex lens section 22a is selectively processed by the laser marker LM2 so that the surface is marked with a visual representation (e.g., “X”) of a failure in the inspection. Since the convex lens section 22a is transparent, marking is preferably provided by processing of discoloration by the laser marker M2 in this case.

As shown in FIG. 2, the wafer lens assembled and inspected in the aforementioned procedure is cut at the concave portion of the lens peripheral projections 12b of adjacent optical members by the blade with a width smaller than that of the concave portion, and is separated into individual lens units.

As described above, the non-conforming products are marked as such. This permits use of the lens unit after separation by exclusion of the non-conforming products. This has the advantage that inadvertent use of the non-conforming product can be avoided even when another different step is used for assembling with sensor units and other processing subsequent to the step of cutting.

When the wafer lens assigned with the wafer ID together with the error information Err thereof is supplied to the aforementioned different step, the worker or the manufacturing machine has the advantage of manufacturing the products without being mixed with non-conforming components, by referencing the wafer ID and error information Err having been supplied.

The above description is based on the assumption that the wafer set composed of a combination of multiple wafer lenses is inspected in the step of inspection. Without the present invention being restricted thereto, a single wafer lens can be inspected in each of the aforementioned inspection steps. The lens unit to be produced can be composed of a single lens, without being restricted to the one composed of a lens set.

1. A method for manufacturing a wafer lens wherein an optical member made of curable resin is formed on a substrate comprising:
a step of measuring a back focus of each lens unit on the wafer;
a step of selecting a spacer having an optimum thickness for combination with the wafer based on a measurement result of the back focus; and
a step of bonding the wafer to the selected spacer.

2. The method for manufacturing a wafer lens described in claim 1, wherein the step of selecting a spacer having an optimum thickness for combination with the wafer based on the measurement result of the back focus includes a step of recording in a data file information for specifying an optimum spacer to be selected, and information for identifying a non-conforming lens unit when the optimum spacer has been selected.

3. A wafer lens with an optical member male of curable resin formed on a substrate comprising:
a diaphragm as an optical component mounted on the substrate and
an identification information recording section mounted on the substrate for recording individual identification information of the wafer lens,
wherein the diaphragm and the identification information recording section are covered with a resin layer for forming the optical component.

4. The wafer lens described in claim 3, wherein the diaphragm and the identification information recording section are formed of the same material arranged on the same layer.

5. The wafer lens described in claim 4, wherein the same material is made of a lightproof photoresist.

6. A wafer lens manufacturing method comprising:
a lamination step for laminating a layer of the same material constituting a diaphragm as an optical component and an identification information recording section for recording individual identification information of the wafer lens, on the substrate;
a patterning step of forming the diaphragm by selectively removing the layer of the same material by patterning;
an identification information recording step for forming the identification information recording section by selectively processing the layer of the same material by a laser marker;
a molding step of filling a curable resin between a surface of the substrate having the diaphragm and the identification information recording section formed thereon, and a molding die, forming an optical member by the molding die using a curable resin as a material, and coating the diaphragm and the identification information recording section with the curable resin; and
a curing step of curing the curable resin.

7. The wafer lens manufacturing method described in claim 6, wherein a layer of lightproof resist is used as the layer of the same material in the lamination step, and the layer of lightproof resist is selectively removed in the identification information recording section subsequent to exposure and development of the layer of lightproof resist in the patterning step, so that the identification information recording section is formed.

8. The wafer lens manufacturing method of claim 6, further comprising:
an inspection step of inspecting the optical member formed on the wafer lens subsequent to the curing process;
an identification information reading step for reading the individual identification information of the wafer lens from the identification information recording section; and
a storage step of storing in a management server inspection information obtained in the inspection step by associating inspection information obtained from the inspection step with the individual identification information of the wafer lens to be inspected.

9. The wafer lens manufacturing method described in claim 8, further comprising a storage step of presetting component identification information for identifying individual optical member for each area for forming the optical member on a wafer lens, and associating the inspection information on each optical member obtained in the inspection step with the individual identification information on the wafer lens to which the optical member to be inspected belong, and the component identification information on the optical member to be inspected, so that this inspection information is stored in a management server.

10. The wafer lens manufacturing method described in claim 9, further comprising a display step wherein a surface map of the wafer lens is displayed on an image display device, and the inspection information of the optical member is displayed on a position corresponding to a region for forming the optical member to be inspected on the surface map, based on the individual identification information, component identification information and inspection information associated with them.

11. The wafer lens manufacturing method described in claim 9, further comprising an inspection failure recording step wherein a laser marker is used to selectively process an optical member to be determined as having failed in the inspection, based on the inspection information after the inspection step, and a visual display is formed to indicate that this optical member has failed in the inspection.
